(19) United States
(12) Patent Application Publication
(10) Pub. No.: US 2017/0270429 A1
(43) Pub. Date: Sep. 21, 2017

(54) METHODS AND SYSTEMS FOR IMPROVED MACHINE LEARNING USING SUPERVISED CLASSIFICATION OF IMBALANCED DATASETS WITH OVERLAP

(71) Applicant: Xerox Corporation, Norwalk, CT (US)

(72) Inventors: Sakyajit Bhattacharya, Bangalore (IN); Vaibhav Rajan, Bangalore (IN)

(73) Assignee: Xerox Corporation

(21) Appl. No.: 15/075,691

(22) Filed: Mar. 21, 2016

(51) Int. Cl. G06N 99/00; G06N 7/00

(52) U.S. Cl. CPC G06N 99/005; G06N 7/005

(57) ABSTRACT

A method and system for data classification using machine learning comprises collecting a dataset with a data collection module, receiving the dataset at a classification module configured for machine learning, dividing the dataset into a plurality of vectors, transforming the plurality of vectors into a plurality of variables wherein each variable is assigned a label, and classifying the variables.

### FIELD OF THE INVENTION

Embodiments are generally related to the field of machine learning. Embodiments are also related to methods and systems for training classifiers to identify features in imbalanced datasets. Embodiments are further related to methods and systems for identifying hazardous seismic activity. Embodiments are further related to methods and systems for segmentation of image attributes. Embodiments are further related to methods and systems for identifying defective motor components in electric current drive signals.

### BACKGROUND

Machine learning is useful for classification of data in a dataset. A dataset is called imbalanced if it contains significantly more samples from one class, termed the majority class, than the other class, known as the minority class. Classification of imbalanced datasets is recognized as an important and difficult problem in machine learning and classification.

Standard classifiers do not work well with imbalanced datasets, mainly because they attempt to reduce the overall misclassification errors and hence, ‘learn’ about the majority class better than the minority class. As a result, the ability of the classifier to identify test samples from the minority class is poor. Noise in the data therefore has a far greater effect on the classification performance for minority class samples. Furthermore, if the minority class has very few data points, it is harder to obtain a generalizable classification boundary between the classes.

Several techniques have been designed to handle imbalanced datasets in machine learning. The three broad classes of techniques designed for imbalanced-data classifications include sampling-based preprocessing techniques, cost-sensitive learning, and kernel-based methods.

In many real world datasets, in addition to class imbalances, the sampling distributions of the features overlap significantly. Overlapping distributions reduce the classification accuracy of most prior art classifiers since test samples from the overlapping region are often misclassified because the classifier has to choose one or the other class. In reality, the data is equally likely to come from either class. Typical solutions to this problem involve transforming the data into a different feature space such that the overlap in the transformed space is minimized. Linear Discriminant Analysis (LDA) and Quadratic Discriminant Analysis (QDA) follow this principle.

When faced with an imbalanced dataset that has significant overlap in the feature distributions, the classification problem becomes even more difficult. Prior art approaches designed for class imbalance cannot deal with overlapping feature distributions. For example, inflating the minority class using SMOTE inflates the overlapping region as well. Methods designed to deal with overlapping feature distributions do not perform well when there is class imbalance; they tend to assign most of the test samples to the majority class. Accordingly, there is a need in the art for methods and systems that address the problem of both imbalance and overlap in machine learning classification applications.

### SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, one aspect of the disclosed embodiments to provide a method and system for machine learning.

It is another aspect of the disclosed embodiments to provide a method and system for feature classification.

It is yet another aspect of the disclosed embodiments to provide an enhanced method and system for training a classifier to correctly classify a minority feature in imbalanced datasets with overlap.

It is another aspect of the disclosed embodiments to provide a method and system for identifying hazardous seismic activity.

It is another aspect of the disclosed embodiments to provide methods and systems for segmentation of image attributes.

It is another aspect of the disclosed embodiments to provide methods and systems for identifying defective motor components in electric current drive signals.

It is another aspect of the disclosed embodiments to provide methods and systems for classifying unbalanced, overlapping data sets related to patient and customer satisfaction, risk assessment, fraud detection, pattern discovery, and analysis of complex data.

The aforementioned aspects and other objectives and advantages can now be achieved as described herein. A method and system for classifying data comprises a sensor which collects a dataset; a processor; a data bus coupled to the processor; and a computer-usable medium embodying computer program code, the computer-usable medium being coupled to the data bus, the computer program code comprising instructions executable by the processor and configured for receiving the dataset at a classification module configured for machine learning, dividing the dataset into a plurality of vectors, transforming the plurality of vectors into a plurality of variables wherein each variable is assigned a label, and classifying the variables.

The system further comprises an offline training stage comprising computing maximum likelihood estimates of parameters and obtaining random variables according to a cubic-quadratic transformation. Transforming the plurality of vectors into a plurality of variables wherein each variable is assigned a label further comprises transforming the plurality of vectors according to the cubic-quadratic transformation from the offline training stage resulting in chi-squared random variables.

### BRIEF DESCRIPTION OF THE FIGURES

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 depicts a block diagram of a computer system which is implemented in accordance with the disclosed embodiments;

FIG. 2 depicts a graphical representation of a network of data-processing devices in which aspects of the present invention may be implemented;

FIG. 3 illustrates a computer software system for directing the operation of the data-processing system depicted in FIG. 1, in accordance with an example embodiment;

FIG. 4 depicts a flow chart illustrating logical operational steps associated with an offline training stage in accordance with the disclosed embodiments;

FIG. 5 depicts a flow chart illustrating logical operational steps for classification of imbalanced datasets in accordance with the disclosed embodiments;

FIG. 6 depicts a block diagram of modules associated with a system and method for classifying imbalanced data sets in accordance with disclosed embodiments; and

FIG. 7 depicts a flow chart illustrating logical operational steps for evaluating a CDF to compute a p-value in accordance with the disclosed embodiments.

### DETAILED DESCRIPTION

The particular values and configurations discussed in these non-limiting examples can be varied and are cited merely to illustrate at least one embodiment and are not intended to limit the scope thereof.

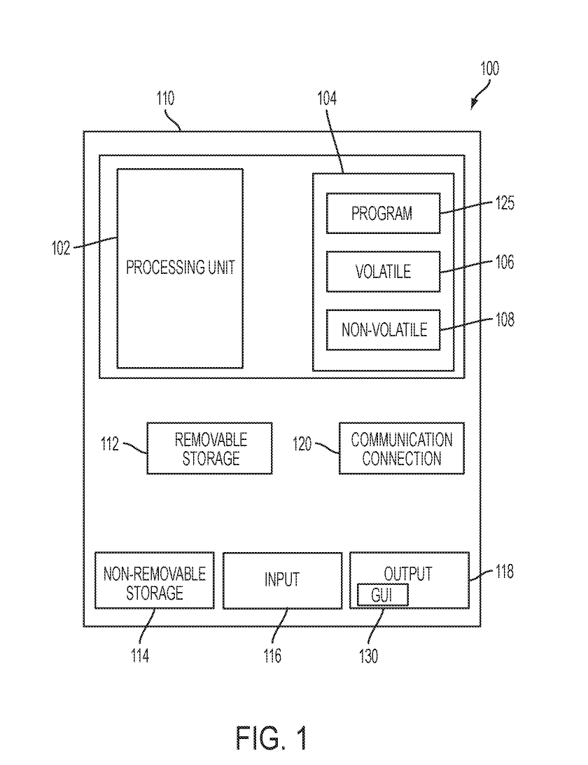

FIGS. 1-3 are provided as exemplary diagrams of data-processing environments in which embodiments of the present invention may be implemented. It should be appreciated that FIGS. 1-3 are only exemplary and are not intended to assert or imply any limitation with regard to the environments in which aspects or embodiments of the disclosed embodiments may be implemented. Many modifications to the depicted environments may be made without departing from the spirit and scope of the disclosed embodiments.

A block diagram of a computer system 100 that executes programming for implementing the methods and systems disclosed herein is shown in FIG. 1. A general computing device in the form of a computer 110 may include a processing unit 102, memory 104, removable storage 112, and non-removable storage 114. Memory 104 may include volatile memory 106 and non-volatile memory 108. Computer 110 may include or have access to a computing environment that includes a variety of transitory and non-transitory computer-readable media such as volatile memory 106 and non-volatile memory 108, removable storage 112 and non-removable storage 114. Computer storage includes, for example, random access memory (RAM), read only memory (ROM), erasable programmable read-only memory (EPROM) and electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage, or other magnetic storage devices, or any other medium capable of storing computer-readable instructions as well as data, including data comprising frames of video.

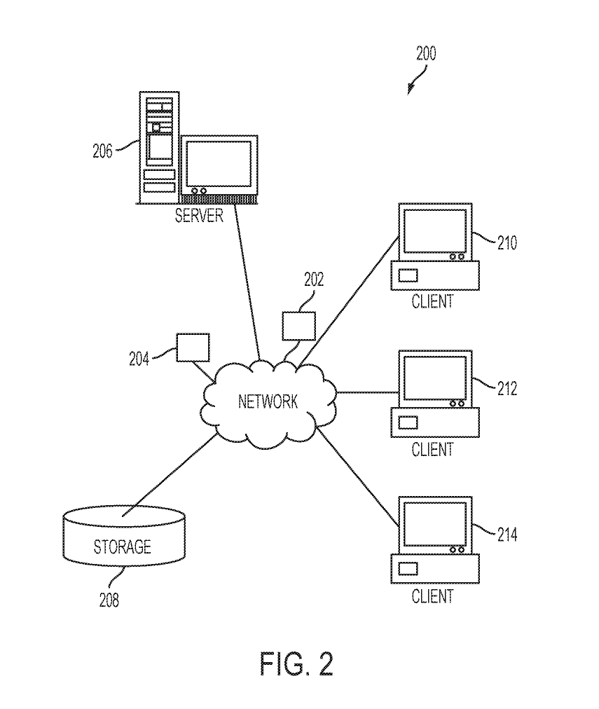

Computer 110 may include or have access to a computing environment that includes input 116, output 118, and a communication connection 120. The computer may operate in a networked environment using a communication connection to connect to one or more remote computers or devices. The remote computer may include a personal computer (PC), server, router, network PC, a peer device or other common network node, or the like. The remote device may include a sensor, photographic camera, video camera, accelerometer, gyroscope, medical sensing device, tracking device, or the like. The communication connection may include a Local Area Network (LAN), a Wide Area Network (WAN), or other networks. This functionality is described in more fully in the description associated with FIG. 2 below.

Output 118 is most commonly provided as a computer monitor, but may include any computer output device. Output 118 may also include a data collection apparatus associated with computer system 100. In addition, input 116, which commonly includes a computer keyboard and/or pointing device such as a computer mouse, computer track pad, or the like, allows a user to select and instruct computer system 100. A user interface can be provided using output 118 and input 116. Output 118 may function as a display for displaying data and information for a user and for interactively displaying a graphical user interface (GUI) 130.

Note that the term “GUI” generally refers to a type of environment that represents programs, files, options, and so forth by means of graphically displayed icons, menus, and dialog boxes on a computer monitor screen. A user can interact with the GUI to select and activate such options by directly touching the screen and/or pointing and clicking with a user input device 116 such as, for example, a pointing device such as a mouse and/or with a keyboard. A particular item can function in the same manner to the user in all applications because the GUI provides standard software routines (e.g., module 125) to handle these elements and report the user's actions. The GUI can further be used to display the electronic service image frames as discussed below.

Computer-readable instructions, for example, program module 125, which can be representative of other modules described herein, are stored on a computer-readable medium and are executable by the processing unit 102 of computer 110. Program module 125 may include a computer application. A hard drive, CD-ROM, RAM, Flash Memory, and a USB drive are just some examples of articles including a computer-readable medium.

FIG. 2 depicts a graphical representation of a network of data-processing systems 200 in which aspects of the present invention may be implemented. Network data-processing system 200 is a network of computers in which embodiments of the present invention may be implemented. Note that the system 200 can be implemented in the context of a software module such as program module 125. The system 200 includes a network 202 in communication with one or more clients 210, 212, and 214. Network 202 is a medium that can be used to provide communications links between various devices and computers connected together within a networked data processing system such as computer system 100. Network 202 may include connections such as wired communication links, wireless communication links, or fiber optic cables. Network 202 can further communicate with one or more servers 206, one or more external devices such as sensor 204, and a memory storage unit such as, for example, memory or database 208.

In the depicted example, sensor 204 and server 206 connect to network 202 along with storage unit 208. In addition, clients 210, 212, and 214 connect to network 202. These clients 210, 212, and 214 may be, for example, personal computers or network computers. Computer system 100 depicted in FIG. 1 can be, for example, a client such as client 210, 212, and/or 214. Alternatively clients 210, 212, and 214 may also be, for example, a photographic camera, video camera, tracking device, sensor, accelerometer, gyroscope, medical sensor, etc.

Computer system 100 can also be implemented as a server such as server 206, depending upon design considerations. In the depicted example, server 206 provides data such as boot files, operating system images, applications, and application updates to clients 210, 212, and 214, and/or to sensor 204. Clients 210, 212, and 214 and sensor 204 are clients to server 206 in this example. Network data-processing system 200 may include additional servers, clients, and other devices not shown. Specifically, clients may connect to any member of a network of servers, which provide equivalent content.

In the depicted example, network data-processing system 200 is the Internet with network 202 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, government, educational, and other computer systems that route data and messages. Of course, network data-processing system 200 may also be implemented as a number of different types of networks such as, for example, an intranet, a local area network (LAN), or a wide area network (WAN). FIGS. 1 and 2 are intended as examples and not as architectural limitations for different embodiments of the present invention.

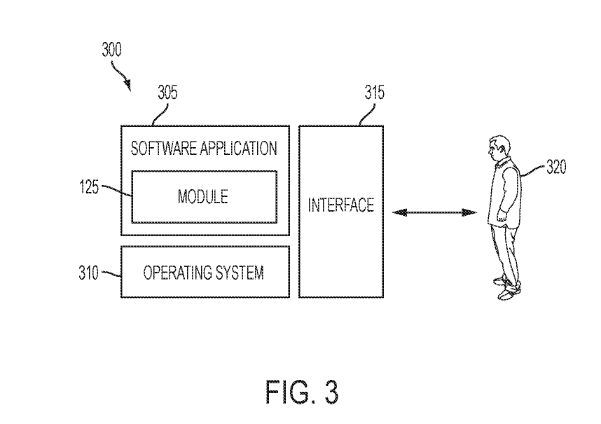

FIG. 3 illustrates a computer software system 300, which may be employed for directing the operation of the data-processing systems such as computer system 100 depicted in FIG. 1. Software application 305, may be stored in memory 104, on removable storage 112, or on non-removable storage 114 shown in FIG. 1, and generally includes and/or is associated with a kernel or operating system 310 and a shell or interface 315. One or more application programs, such as module(s) 125, may be “loaded” (i.e., transferred from removable storage 112 into the memory 104) for execution by the data-processing system 100. The data-processing system 100 can receive user commands and data through user interface 315, which can include input 116 and output 118, accessible by a user 320. These inputs may then be acted upon by the computer system 100 in accordance with instructions from operating system 310 and/or software application 305 and any software module(s) 125 thereof.

Generally, program modules (e.g., module 125) can include, but are not limited to, routines, subroutines, software applications, programs, objects, components, data structures, etc., that perform particular tasks or implement particular abstract data types and instructions. Moreover, those skilled in the art will appreciate that the disclosed method and system may be practiced with other computer system configurations such as, for example, hand-held devices, multi-processor systems, data networks, microprocessor-based or programmable consumer electronics, networked personal computers, minicomputers, mainframe computers, servers, and the like.

Note that the term module as utilized herein may refer to a collection of routines and data structures that perform a particular task or implements a particular abstract data type. Modules may be composed of two parts: an interface, which lists the constants, data types, variable, and routines that can be accessed by other modules or routines; and an implementation, which is typically private (accessible only to that module) and which includes source code that actually implements the routines in the module. The term module may also simply refer to an application such as a computer program designed to assist in the performance of a specific task such as word processing, accounting, inventory management, etc.

The interface 315 (e.g., a graphical user interface 130) can serve to display results, whereupon a user 320 may supply additional inputs or terminate a particular session. In some embodiments, operating system 310 and GUI 130 can be implemented in the context of a “windows” system. It can be appreciated, of course, that other types of systems are possible. For example, rather than a traditional “windows” system, other operation systems such as, for example, a real time operating system (RTOS) more commonly employed in wireless systems may also be employed with respect to operating system 310 and interface 315. The software application 305 can include, for example, module(s) 125, which can include instructions for carrying out steps or logical operations such as those shown and described herein.

The following description is presented with respect to embodiments of the present invention, which can be embodied in the context of a data-processing system such as computer system 100, in conjunction with program module 125, and data-processing system 200 and network 202 depicted in FIGS. 1-3. The present invention, however, is not limited to any particular application or any particular environment. Instead, those skilled in the art will find that the system and method of the present invention may be advantageously applied to a variety of system and application software including database management systems, word processors, and the like. Moreover, the present invention may be embodied on a variety of different platforms including Macintosh, UNIX, LINUX, and the like. Therefore, the descriptions of the exemplary embodiments, which follow, are for purposes of illustration and not considered a limitation.

Imbalanced datasets are common in many real world applications. For example, in applications for the diagnosis of cancer, datasets often have more patients without cancer than patients with cancer. Thus, the patients with cancer are the minority class. And it is more important, in such a case, for a classifier to identify samples from the minority class. That is, it is desirable for a classifier to correctly identify patients with cancer so that they can be properly treated. Many other examples exist in the areas of text categorization, fault detection, speech recognition, fraud detection, oil-spill detection in satellite images, toxicology, medical diagnosis, and bioinformatics.

The embodiments disclosed herein describe novel classification methods and systems to address the problems of both imbalance and overlap in datasets. The embodiments exploit the class imbalance in the dataset to achieve a transformation of the features such that the transformed features are well separated. This transformation is achieved using sample skewness measures, assuming that the features follow a Gaussian distribution, which is a common and realistic assumption. Thus, Gaussian random variables are transformed into chi-squared random variables where the degree of freedom depends on the mean, variance, and the class size in the training data, thereby accounting for the class imbalance.

During a prediction stage, the features of the data can be divided into an odd number of subsets, each of fixed dimensions, ensuring that the transformation remains valid within each subset. For each subset, a classification label is obtained through hypothesis testing to determine whether the difference of two chi-squared variables belong to the same distribution or not. When the dimensionality of the data is less than a selected metric, preferably eight (which can be enforced for the subsets), approximations for the cumulative distribution function (CDF) for a difference of two chi-squared variables can be used for hypothesis testing. A majority voting scheme can then be used (on the labels obtained from classifying each subset) to determine the final classification.

The embodiments disclosed herein address many of the problems encountered in diverse domains and achieve better classification outcomes. Empirical evidence demonstrates the superiority of the embodiments as applied to real world datasets including, but not limited to, identifying hazardous seismic activity, segmentation of image attributes, identifying defective motor components in electric current drive signals, classifying patient and customer satisfaction, risk assessment, fraud detection, pattern discovery, analysis of complex data, text categorization, fault detection, speech recognition, fraud detection, oil-spill detection in satellite images, toxicology, medical diagnosis, and bioinformatics all of which may include imbalanced and overlapped data as provided herein.

In one embodiment, a binary classification problem is defined as the task of classifying elements of a given set of data into two groups according to some classification rule. A binary classification can be provided using a binary classification algorithm. However, the binary classification algorithm is a form of machine learning that requires training. Thus, in an embodiment a binary classification method requires a simple training procedure that computes two scalar values from the training data as described herein.

Let A and B be two classes in the context of the given binary classification problem where the training data in class A has n_{A} observations and training data in class B has n_{B} observations with n_{A}>>n_{B}. This defines an imbalanced dataset. The training observations in class A can be denoted as x=(x₁, . . . , x_{nA}) and the training observations in class B as y=(y₁, . . . , y_{nA}). Let d be the dimension of each observation. Assume x, follows a distribution with mean μ_{A} and variance Σ_{A} and yᵢ follows a distribution with mean μ_{B} and variance Σ_{B} for each i and j.

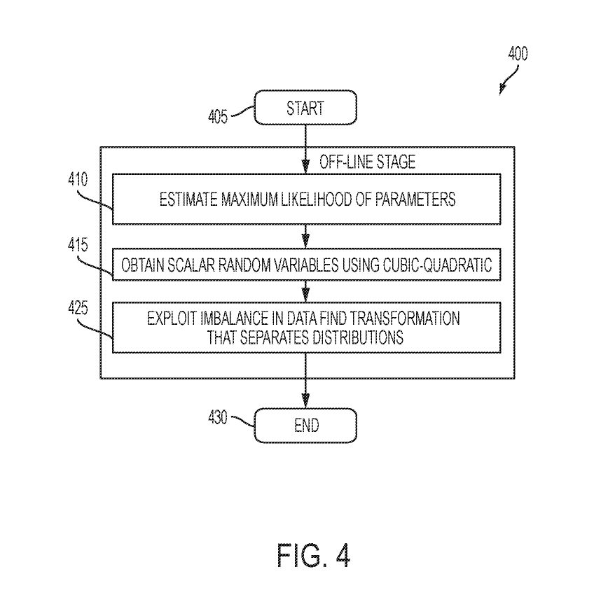

A method 400, including steps associated with an offline stage for training a classifier, is illustrated in FIG. 4. The method begins at step 405. In step 410, the maximum likelihood estimates of the parameters are computed according to Equations (1), (2), and (3).

$$\begin{matrix}{\hat{μ}}_{A} = \frac{1}{{n}_{A}} {\sum }_{i = 1}^{{n}_{A}} {x}_{i} , {\hat{μ}}_{B} = \frac{1}{{n}_{B}} {\sum }_{j = 1}^{{n}_{B}} {y}_{j} & ( 1 ) \\ {\hat{Σ}}_{A} = \frac{1}{{n}_{A}} {\sum }_{i = 1}^{{n}_{A}} ( {x}_{i} - {\hat{μ}}_{A} ) {( {x}_{i} - {\hat{μ}}_{A} )}^{T} & ( 2 ) \\ {\hat{Σ}}_{B} = \frac{1}{{n}_{B}} {\sum }_{j = 1}^{{n}_{B}} ( {y}_{j} - {\hat{μ}}_{B} ) {( {y}_{j} - {\hat{μ}}_{B} )}^{T} & ( 3 )\end{matrix}$$

Next, at step 415 for each class, from the training observations x and y, obtain (scalar) random variables U and V through a cubic-quadratic transformation as given by equations (4) and (5).

$$\begin{matrix}U = {\sum }_{i = 1}^{{n}_{A}} {\sum }_{j = 1}^{{n}_{A}} {[ {( {x}_{i} - {\hat{μ}}_{A} )}^{T} {{\hat{Σ}}_{A}^{- 1} ( {x}_{j} - {\hat{μ}}_{A} )}^{T} ]}^{3} & ( 4 ) \\ V = {\sum }_{i = 1}^{{n}_{B}} {\sum }_{j = 1}^{{n}_{B}} {[ {( {y}_{i} - {\hat{μ}}_{B} )}^{T} {{\hat{Σ}}_{B}^{- 1} ( {y}_{j} - {\hat{μ}}_{B} )}^{T} ]}^{3} & ( 5 )\end{matrix}$$

Variables U and V are measures of skewness of the distributions of x and y. For multivariate normal x and y, the distribution of ⅙ n_{A} U and ⅙ n_{B} V, asymptotically follow the χ² distribution with the degree of freedom d(d+1)(d+2)/6 is given by:

U˜6n_{A}χ_{d(d+1)(d+2)/6}²,V˜6n_{B}χ_{d(d+1)(d+2)/6}². (6)

Since n_{A} and n_{B} are different, the means of U and V that depend explicitly on the values of n_{A} and n_{B} are well separated. Thus, the imbalance in the data can be exploited to achieve a transformation that separates the distributions of U and V considerably, as shown at step 425.

The separation in the distributions is proportional to the difference in the class sizes: the more the difference, the better separation we achieve. The separation is also influenced by the differences in the means and variances of the distributions of x and y. Note that skewness measures of the sampling distributions can be used; not the true distributions. The latter can be assumed to be Gaussian, and hence, is perfectly symmetric (zero skewness) whereas the former need not be perfectly symmetric. Since the transformation uses the class sizes, the transformed variables will follow different χ² distributions.

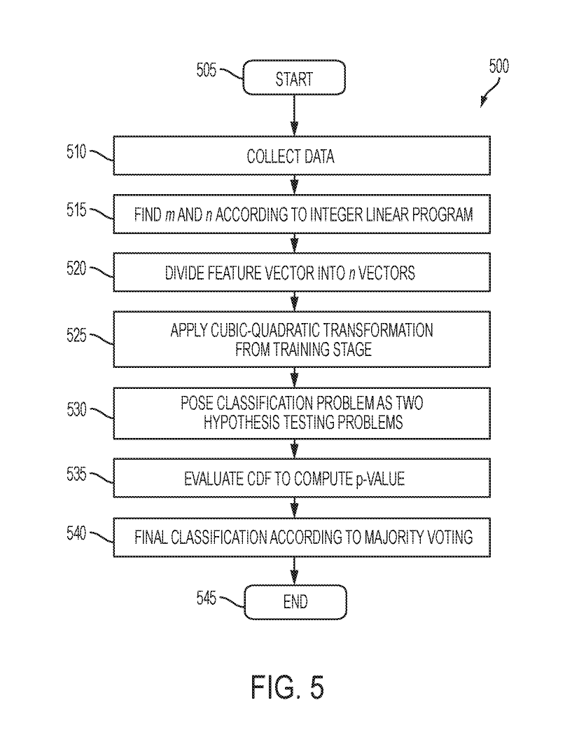

After training is complete, online classification of a desired data sample can be performed. A method 500, including logical operational steps for classifying a sample using a classifier is illustrated in FIG. 5. It should be understood that a preliminary offline training stage, such as the method illustrated in FIG. 4 may be necessary before implementation of the method 500.

The method begins at step 505. For purposes of explanation the classification described below can be thought of as classifying a sample Z of dimension p. In certain embodiments, the sample Z may relate to text categorization, fault detection, speech recognition, fraud detection, oil-spill detection in satellite images, toxicology, medical diagnosis, bioinformatics, or other such imbalanced data sets. At step 510, the data associated with the sample can be collected with a sensor, video camera, photographic camera, accelerometer, GPS enabled device, etc.

At step 515, an integer linear program is used to find m and n. The integer linear program involves maximizing m such that mn=p; m≦t; 2q+1=n; and m, n, q, ε∥.

LP solvers can be used to solve this program and obtain non-integral solutions to m. A threshold t is a user-determined input. Next, one can then obtain ┌m┐ or └m┘ by randomly rounding (above or below), ensuring mn=p.

Next at step 520, the p-dimensional feature vector is divided into n vectors, each of dimension ┌m┐ or └m┘ as chosen above. Note that n is odd, ensuring that there are an odd number of vectors, each denoted by Zₙ. In an embodiment, the threshold t=7, for example, can be chosen in step 515, which ensures that the dimension of each Zₙ is not greater than 7. This ensures that the transformations in step 525 results in chi-squared random variables. Steps 525 and 530 are then performed on each of these vectors.

Step 525 involves applying the same cubic-quadratic transformations on Zₙ that were applied during training to obtain two variables as given in equations (7) and (8).

Z₁=⅙[(Zₙ−\hat{μ}_{A})^{T}\hat{Σ}_{A}⁻¹(Zₙ−\hat{μ}_{A})]³ (7)

Z₂=⅙[(Zₙ−\hat{μ}_{B})^{T}\hat{Σ}_{B}⁻¹(Zₙ−\hat{μ}_{B})]³ (8)

In step 530, the classification problem can be posed as two hypothesis-testing problems. T is denoted by the test statistic (i.e., difference of two independent χ² random variables). The CDF is then evaluated to compute the p-value as shown in step 535.

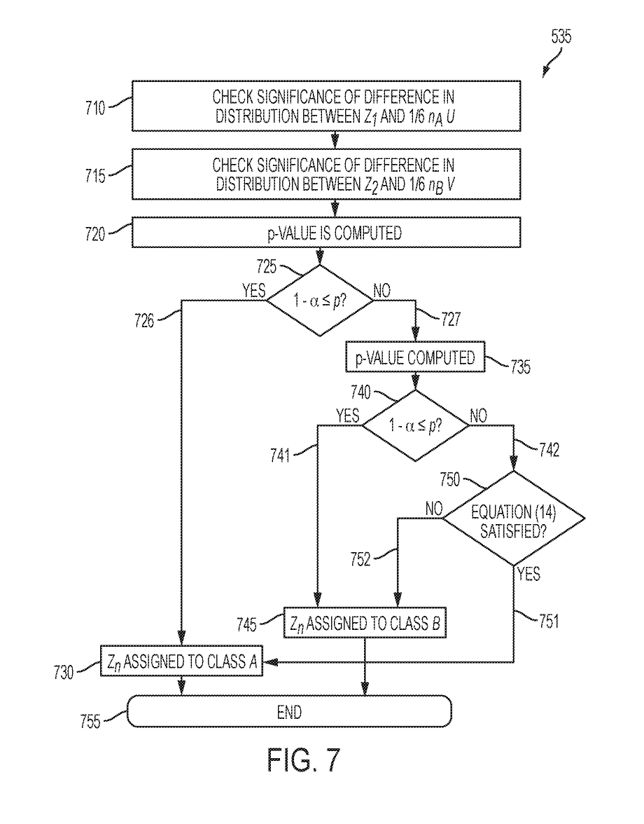

FIG. 7 illustrates a flow chart of steps associated with evaluating the CDF to compute the p-value as shown in step 535 of FIG. 5. In a first step 710, a test checks the significance of the difference (in distribution) between Z₁ and ⅙ n_{A} U. The null hypothesis is H₁₀ with the alternative hypothesis being H₁₁. These are given as equations (9) and (10).

[symbol]

₁₀:P(T>|Z₁−⅙n_{A}U|)≧1−α (9)

vs.

[symbol]

₁₁:P(T>|Z₁−⅙n_{A}U|)<1−α (10)

In step 715, a second test checks the significance of the difference (in distribution) between Z₂ and ⅙ n_{B} V. The null hypothesis is H₂₀ with the alternative hypothesis being H₂₁. These are given as equations (11) and (12).

[symbol]

₂₀:P(T>|Z₂−⅙n_{B}V|)≧1−α (11)

vs.

[symbol]

₂₁:P(T>|Z₂−⅙n_{B}V|)<1−α. (12)

where T is the difference of two χ² distributions as shown by equation (13)

T=χ_{d(d+2)(d+4)/6}²−χ_{d(d+1)(d+2)/6}² (13)

and α is the level of significance.

Next at step 720, the p-value is computed such that, p=P(T>Z₁−U₀) where Z₁−U₀ is positive. If Z₁−U₀ is negative, the p-value is given by p=P(T≦Z₁−U₀). If 1−α≦p as shown at step 725 is yes at step 726, then Zₙ can be assigned to class A at step 730, and the method ends at step 755. Otherwise the method progresses to step 735 from no block 727.

At step 735, the p-value is computed such that, p=P(T>Z₂−V₀) where Z₂−V₀ is positive. If Z₂−V₀ is negative, the p-value is given by p=P(T≦Z₂−V₀). If 1−α≦p as shown at step 740 is yes step 741, then Zₙ can be assigned to class B at step 745, and the method ends at step 755. Otherwise the method progresses to step 750 from no step 742.

At step 750, if equation (14) is satisfied at yes step 751, Zₙ is assigned to class A at step 730. Otherwise, no step 752 is satisfied and Zₙ is assigned to class B at step 745. The method illustrated in FIG. 7 ends at step 755.

$$\frac{1}{{n}_{A}} {\sum }_{i = 1}^{{n}_{A}} {( Z - {x}_{i} )}^{2} < \frac{1}{{n}_{B}} {\sum }_{j = 1}^{{n}_{B}} {( Z - {y}_{j} )}^{2} \qquad ( 14 )$$

After obtaining n labels on each of the n vectors, at step 520 the final classification is done using majority voting at step 540. Since n is odd, there will always be a majority. For hypothesis testing, the p-value corresponding to the observed value (t) of the test statistic (T) is computed. The p-value represents the probability, under the null hypothesis, of sampling a test statistic at least as extreme as that which was observed (i.e., P(T>t), for positive t). The null hypothesis is rejected and the alternative hypothesis accepted if the p-value is less than the significance level threshold.

For example, let Z³ denote the component-wise cube of the test sample vector. Also, let equation (15) denote the maximum likelihood estimate (MLE) of the variance of Z³ based on observations of class A.

[symbol]

(Z³) (15)

[symbol]

(n_{A}⁻¹) (16)

Assuming that equation (15)=equation (16) in probability, it can be shown that the test statistic is asymptotically a difference of two independent χ² variables. An equivalent statement holds for equation (17).

Z₂−⅙n_{B}V (17)

The assumption on equation (15) is to ensure that the skewness of the distribution of Z is very low which holds for Gaussian-like distributions. To compute the p-value, the CDF of the distribution is needed, for which there is no closed form. Approximations exist that can be used alternatively. The method ends at step 545.

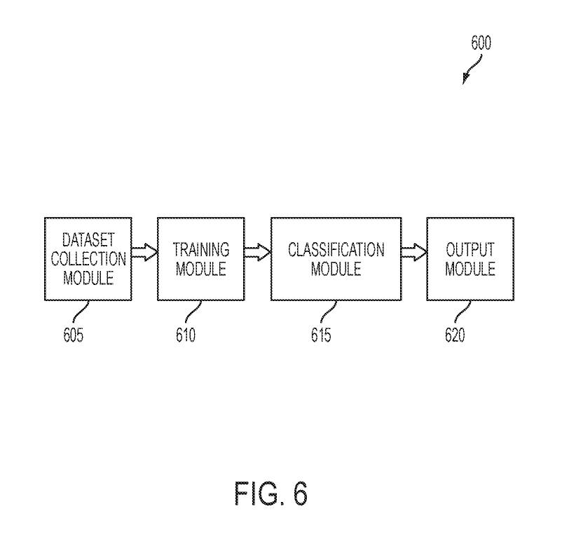

FIG. 6 illustrates a block diagram 600 of a system for classification of an unbalanced and overlapping dataset. The modules associated with block diagram 600 may be employed to realize the methods disclosed herein, for example in FIG. 4, FIG. 5, and FIG. 7. The system 600 includes a dataset collection module 605. The dataset collection module 605 may include any number of sensors, cameras, video or audio recording devices, seismic devices, accelerometers, gyroscopes, medical recording devices, etc. In addition, the dataset collection module can be embodied as a computer system where a user enters a dataset.

Training module 610 is a machine learning module used to train the classifier as illustrated in FIG. 4. It should be appreciated that the training module 610 can be performed “offline” during a training stage. During the training stage, an unbalanced and/or overlapping dataset classifier can be trained to accurately classify data, preferably relating to the data collected or entered in the dataset collection module 605.

Once the training module 610 has trained a classifier, the classification module 615 can classify the dataset collected form the dataset collection module 605. The classification module 615 performs the steps necessary for classifying the unbalanced and overlapping data according to the steps illustrated in FIG. 5 and FIG. 7. Once the classification module has classified the dataset, the output module 620 provides an output indicating the classification results.

It should be appreciated that the classification system 600 can be implemented in a number of applications. For example, the classification system 600 can be implemented as a medical diagnosis system for classifying medical data in order to determine if the data is indicative of a medical condition such as cancer. The classification system may also be implemented as a seismic bump classification system, an image segmentation system, or a drive diagnosis system.

The embodiments described herein can be used on data sets indicative of real world phenomena. Such datasets and the experimental results obtained are provided below.

An Area Under the Receiver Operating Characteristics (ROC) Curve (AUC) can be used as an evaluation metric, as it considers the complete ROC curve for evaluating classifier performance. In the disclosed embodiments, different operating points on the curve can be obtained by varying the level of significance, a, in hypothesis testing. All results shown are over five-fold cross validation.

As baselines for comparisons, an SVM with several different preprocessing techniques was used. One such technique is under sampling where the majority class is sampled to equalize the number of samples in both classes during training (denoted by SVM-UN), SMOTE (SVM-SMOTE), cost-sensitive SVM (CSL), and CLUSBUS (CLUSBUS). For CSL, the weight of each sample is inversely proportional to the number of (training) samples in the class to which it belongs. Best parameters for SVM are obtained by cross-validation on the training samples. Random Forest (RF), Linear Discriminant Analysis (LDA), and Quadratic Discriminant Analysis (QDA) with these preprocessing techniques were also evaluated. Given that the performance of SVM is understood to be better or comparable to these classifiers, only the results of SVM for synthetic datasets is shown. The classifier illustrated by the embodiments herein is denoted by CE.

In one embodiment, data related to Seismic Bumps can be evaluated according to the systems and methods disclosed herein. Seismic Bump datasets are generally imbalanced and overlapping, and therefore represent a good dataset for application of the present embodiments.

An exemplary dataset includes 19 geophysical attributes for 2584 instances. The task is to distinguish between hazardous seismic states and non-hazardous seismic states. The imbalance ratio is 14:1. Table 1 illustrates the mean AUC of the embodiments disclosed herein that outperforms every other method.

TABLE 1
Mean AUC, over five fold CV, of classifiers
on Seismic Bumps databaset.

| CE | SVM-SMOTE | SVM-UN | CLUSBUS | CSL |
|---|---|---|---|---|
| 89.07 | 84.56 | 73.87 | 87.56 | 71.63 |

In another exemplary embodiment, image segmentation data can be evaluated according to the systems and methods disclosed herein. Image segmentation data is also commonly imbalanced and overlapping and therefore a good candidate for the methods and systems disclosed herein.

In an exemplary embodiment, 19 attributes of images (such as color intensities, pixel counts, line densities, etc.) were included in a dataset. The task in this embodiment is to segment given regions of the images. The exemplary dataset includes 2310 instances and an imbalance ratio of 6:1. Table 2 shows the mean AUC of the classifier that outperforms every other method.

TABLE 2
Mean AUC, over five fold CV, of classifiers
on Image Segmentation dataset.

| CE | SVM-SMOTE | SVM-UN | CLUSBUS | CSL |
|---|---|---|---|---|
| 99.13 | 98.01 | 93.39 | 97.38 | 87.43 |

In yet another exemplary embodiment, sensorless drive diagnosis data can be evaluated according to the systems and methods disclosed herein. Sensorless drive diagnosis data is also commonly imbalanced and overlapping and therefore a good candidate for the methods and systems disclosed herein.

In an exemplary embodiment, a task is to distinguish between intact and defective motor components in electric current drive signals. Features can be extracted from different operating conditions such as different speeds, load moments, and load forces. This embodiment includes 58509 instances, 48 features, and imbalance ratio of 10:1. Table 3 shows the mean AUC of the embodied classifier that outperforms every other method.

TABLE 3
Mean AUC, over five fold CV, of classifiers
on Sensorless Drive Diagnosis dataset.

| CE | SVM-SMOTE | SVM-UN | CLUSBUS | CSL |
|---|---|---|---|---|
| 77.19 | 74.65 | 62.93 | 75.56 | 63.76 |

Imbalanced datasets with overlapping feature distributions are common in many real world applications. The classification methods and systems disclosed herein are the first to address both these problems simultaneously. Extensive applications of such a classifier can be found, for example, in healthcare—where imbalanced datasets are the norm rather than the exception. Applications in other fields also exist. For example, defaulters in finance from the minority class and fraud detection can use classifiers to identify them, automatic routing of calls in call centers uses classification, and high-priority calls are fewer in number and form the minority class.

Based on the foregoing, it can be appreciated that a number of embodiments, preferred and alternative, are disclosed herein. For example, in one embodiment, a method of machine learning for classification of data comprises collecting a dataset with a data collection module, receiving the dataset at a classification module configured for machine learning, dividing the dataset into a plurality of vectors, transforming the plurality of vectors into a plurality of variables wherein each variable is assigned a label, and classifying the variables.

In an embodiment, the method further comprises an offline training stage comprising computing maximum likelihood estimates of parameters and obtaining random variables according to a cubic-quadratic transformation. Transforming the plurality of vectors into a plurality of variables wherein each variable is assigned a label further comprises transforming the plurality of vectors according to the cubic-quadratic transformation from the offline training stage resulting in chi-squared random variables.

In another embodiment, dividing the data into a plurality of vectors further comprises solving a program using LP solvers. The program is an integer linear program. In another embodiment, the dataset comprises an unbalanced dataset with overlap.

In an embodiment, the dataset comprises data associated with one of medical diagnosis, seismic activity, image segmentation, and drive diagnosis.

In another embodiment, a system for classifying data comprises a sensor which collects a dataset; a processor; a data bus coupled to the processor; and a computer-usable medium embodying computer program code, the computer-usable medium being coupled to the data bus, the computer program code comprising instructions executable by the processor and configured for receiving the dataset at a classification module configured for machine learning, dividing the dataset into a plurality of vectors, transforming the plurality of vectors into a plurality of variables wherein each variable is assigned a label and classifying the variables.

The system further comprises an offline training stage comprising computing maximum likelihood estimates of parameters and obtaining random variables according to a cubic-quadratic transformation. Transforming the plurality of vectors into a plurality of variables wherein each variable is assigned a label further comprises transforming the plurality of vectors according to the cubic-quadratic transformation from the offline training stage resulting in chi-squared random variables.

In another embodiment of the system, dividing the data into a plurality of vectors further comprises solving a program using LP solvers. The program is an integer linear program. In another embodiment, the dataset comprises an unbalanced dataset with overlap.

In an embodiment of the system, the dataset comprises data associated with one of medical diagnosis, seismic activity, image segmentation, and drive diagnosis.

In yet another embodiment, a medical diagnostic system comprises a sensor which collects a dataset; a processor; a data bus coupled to the processor; and a computer-usable medium embodying computer program code, the computer-usable medium being coupled to the data bus, the computer program code comprising instructions executable by the processor and configured for receiving the dataset at a classification module configured for machine learning, dividing the dataset into a plurality of vectors, transforming the plurality of vectors into a plurality of variables wherein each variable is assigned a label, and classifying the variables as indicative of the presence or absence of a medical condition.

In another embodiment of the medical diagnostic system, an offline training stage comprises computing maximum likelihood estimates of parameters and obtaining random variables according to a cubic-quadratic transformation. Transforming the plurality of vectors into a plurality of variables wherein each variable is assigned a label further comprises transforming the plurality of vectors according to the cubic-quadratic transformation from the offline training stage resulting in chi-squared random variables.

In another embodiment, dividing the data into a plurality of vectors further comprises solving an integer linear program using LP solvers.

In another embodiment, the dataset comprises an unbalanced data set with overlap of indicators of the presence or absence of a medical condition. In another embodiment, the dataset comprises at least one indicator of the presence of absence of cancer.

It will be appreciated that variations of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

What is claimed is:

1. A method of machine learning for classification of data comprising:
collecting a dataset with a data collection module;
receiving said dataset at a classification module configured for machine learning;
dividing said dataset into a plurality of vectors;
transforming said plurality of vectors into a plurality of variables wherein each variable is assigned a label; and
classifying said variables.

2. The method of claim 1 further comprising an offline training stage comprising:
computing maximum likelihood estimates of parameters; and
obtaining random variables according to a cubic-quadratic transformation.

3. The method of claim 2 wherein transforming said plurality of vectors into a plurality of variables wherein each variable is assigned a label further comprises:
transforming said plurality of vectors according to said cubic-quadratic transformation from said offline training stage resulting in chi-squared random variables.

4. The method of claim 1 wherein dividing said data into a plurality of vectors further comprises:
solving a program using LP solvers.

5. The method of claim 3 wherein said program is an integer linear program.

6. The method of claim 1 wherein said dataset comprises an unbalanced dataset with overlap.

7. The method of claim 6 wherein said dataset comprises data associated with one of:
medical diagnosis;
seismic activity;
image segmentation; and
drive diagnosis.

8. A system for classifying data comprising:
a sensor which collects a dataset;
a processor;
a data bus coupled to said processor; and
a computer-usable medium embodying computer program code, said computer-usable medium being coupled to said data bus, said computer program code comprising instructions executable by said processor and configured for:
receiving said dataset at a classification module configured for machine learning;
dividing said dataset into a plurality of vectors;
transforming said plurality of vectors into a plurality of variables wherein each variable is assigned a label; and
classifying said variables.

9. The system of claim 8 further comprising an offline training stage comprising:
computing maximum likelihood estimates of parameters; and
obtaining random variables according to a cubic-quadratic transformation.

10. The system of claim 9 wherein transforming said plurality of vectors into a plurality of variables wherein each variable is assigned a label further comprises:
transforming said plurality of vectors according to said cubic-quadratic transformation from said offline training stage resulting in chi-squared random variables.

11. The system of claim 8 wherein dividing said data into a plurality of vectors further comprises:
solving a program using LP solvers.

12. The system of claim 11 wherein said program is an integer linear program.

13. The system of claim 8 wherein said dataset comprises an unbalanced dataset with overlap.

14. The system of claim 13 wherein said dataset comprises data associated with one of:
medical diagnosis;
seismic activity;
image segmentation; and
drive diagnosis.

15. A medical diagnostic system comprising:
a sensor which collects a dataset;
a processor;
a data bus coupled to said processor; and
a computer-usable medium embodying computer program code, said computer-usable medium being coupled to said data bus, said computer program code comprising instructions executable by said processor and configured for:
receiving said dataset at a classification module configured for machine learning;
dividing said dataset into a plurality of vectors;
transforming said plurality of vectors into a plurality of variables wherein each variable is assigned a label; and
classifying said variables as indicative of the presence or absence of a medical condition.

16. The medical diagnostic system of claim 15 further comprising an offline training stage comprising:
computing maximum likelihood estimates of parameters; and
obtaining random variables according to a cubic-quadratic transformation.

17. The system of claim 16 wherein transforming said plurality of vectors into a plurality of variables wherein each variable is assigned a label further comprises:
transforming said plurality of vectors according to said cubic-quadratic transformation from said offline training stage resulting in chi-squared random variables.

18. The system of claim 15 wherein dividing said data into a plurality of vectors further comprises:
solving an integer linear program using LP solvers.

19. The system of claim 15 wherein said dataset comprises an unbalanced dataset with overlap of indicators of the presence or absence of a medical condition.

20. The system of claim 19 wherein said dataset comprises at least one indicator of the presence of absence of cancer.
